(19) United States
(12) Patent Application Publication
(10) Pub. No.: US 2016/0210675 A1
(43) Pub. Date: Jul. 21, 2016

(54) ORDERING PRODUCTS / SERVICES

(71) Applicant: SMART SHIP HOLDINGS LIMITED, Tortola (VG)

(72) Inventor: Billy Jay Junior SMART, Monte Carlo (MC)

(21) Appl. No.: 14/910,742

(22) PCT Filed: Aug. 7, 2014
(86) PCT No.: PCT/GB2014/052422

§ 371 Date: Feb. 8, 2016

(30) Foreign Application Priority Data
Aug. 7, 2013 (GB) 1314091.8

(51) Int. Cl. G06Q 30/06; G06Q 10/02; G06Q 50/26; H04W 4/02; H04W 4/12; G06Q 50/30; G06Q 50/12

(52) U.S. Cl. CPC G06Q 30/0613; G06Q 30/0639; G06Q 50/30; G06Q 10/02; G06Q 50/12; H04W 4/025; H04W 4/12; G06Q 50/26

(57) ABSTRACT

A system and method of assisting a customer with obtaining a service or a product is disclosed. The method includes receiving a request for a service or product from a customer device, processing the request using a processing system, to identify at least one potential provider of the service or the product. The method further comprises sending provider information relating to at least one of the identified potential providers to the customer device.

The present invention relates to assisting with obtaining products and/or services.

It is known to order goods and services remotely, e.g. via the telephone or using websites. However, in many cases, the ordering process is not streamlined and cannot be done easily whilst travelling, e.g. booking a taxi or restaurant whilst on the move. Further, although many businesses offer website-based ordering services, they do not integrate the ordering with their stock management systems.

Embodiments of the present invention are intended to address at least some of the abovementioned problems. Embodiments can be particularly appealing to customers who are time sensitive.

According to a first aspect of the present invention there is provided a method of assisting a customer with obtaining a service or a product, the method including or comprising:

receiving a request for a service or product from a customer device;

processing the request to identify at least one potential provider of the service or the product;

sending provider information relating to at least one of the identified potential providers to the customer device.

The method may further include:

requesting confirmation from the customer device after providing the providing information, and

upon the customer device giving the requested confirmation then sending a confirmation signal to the provider in the provider information.

The customer request may include details regarding current location of the customer device. The current location information may be obtained by means of a GPS signal or the like. The step of processing the request may include comparing the current location of the customer device with a location of a provider.

The method may include, prior to the step of providing the provider information, a step of seeking confirmation from a said identified provider regarding whether the provider agrees to the provider information being provided to the customer device and/or confirmation that the provider is prepared to fulfil the customer request. The method may include seeking the confirmation within a time limit. In some embodiments, if no confirmation is received within the time limit then automatic confirmation is provided on behalf of the provider.

If the step of processing the request identifies a plurality of said potential providers then the method may include selecting one of the potential providers. In some embodiments, a first of the potential providers to accept the customer request is selected.

The method may include updating a data store holding product (or service-related) stock information for a said provider in view of provision of the product or the service to the customer. The method may further include producing a re-stocking order as a result of the updating.

The method may include calculating a price for the product/service specified in the customer request. The calculation of the price may involve information from a data store holding the stock information and/or time/date of provision of the product/service, etc.

The service may comprise a taxi service. The customer request may include details of a destination. The customer request may include information regarding a time when the customer wishes to be picked up by a taxi. The customer request may include information regarding a number of passengers. The customer request may include information regarding customer luggage. The customer request may include an indication of whether the customer is prepare to share a taxi with another customer and/or an indication of whether the customer requires exclusive use of the taxi with no other customers. Where the method includes calculating a price for the service, the calculation of the price of the taxi may involve a distance relating to a pick up point and destination; a number (or weight) of passengers; an amount (or weight) of luggage; whether the customer is sharing at least part of the taxi journey with at least one other customer (who made an independent request). The calculation of the price of the taxi may involve cost information taken from one of a plurality of user-selected tariffs.

The step of processing the request may include obtaining information regarding locations of taxis; information regarding schedules of taxis; information regarding fuel levels of taxies; information regarding timing of rest breaks/working hours of drivers of taxis; information regarding traffic conditions between a current location of a taxi and the current location of the customer device, and/or information regarding traffic conditions between the current location of the customer device and the specified destination. The method may further include displaying information regarding current location of the taxi on the customer device. The current taxi location information may be displayed in a graphical format, including directions to the current taxi location with respect to a current location of the customer device. The current taxi location may be superimposed on an image of an environment in which the customer device is located. The method may further include displaying information regarding a current location of the customer device to a taxi-fitted device.

The service may comprise a restaurant booking. The customer request may include information regarding food and/or drink to be included in the restaurant booking. The customer request may include a start time for the restaurant booking. The customer request may include an end time and/or a desired duration of the restaurant booking. The customer request may specify a name of a restaurant. The customer request may specify a style of cuisine and the step of processing the customer request can include identifying restaurants that provide the specified style of cuisine. The method may further include displaying direction to the restaurant on the customer device.

The service may comprise a mass transport service, such as a bus or coach. The method may comprise sending a message to the customer device prior to the transport service arriving at a pick-up point. A time at when the message is sent may be calculated based on a distance between a current location of the customer device and the pick-up point.

The product may comprise takeaway food or any consumer goods. The service may comprise a courier; a rescue/emergency service; a travel ticket; holiday accommodation, etc.

According to another aspect of the present invention there is provided a system including or comprising:

a customer device configured to produce a request for a service or product;

a processing system configured to:
receive the request from the customer device (102); and
process the request to identify at least one potential provider of the service or the product; and
send provider information relating to the identified at least one potential provider to the customer device.

The customer device may be further configured to send confirmation to the processing system after receiving the provider information.

The system may further include an identification device for a vehicle, the identification device including a communications device for receiving a signal from the processing system and/or the customer device. The identification device may change visibly (e.g. light up) upon receipt of a signal from the processing system or the customer device in order to assist the customer with identifying the vehicle. The identification device may be configured to convey a taxi status, e.g. occupied, available, available to share, or unavailable.

The system may further include at least one vehicle-mounted sensor. A said sensor may be configured in use to detect a number of passengers in the vehicle (or spare passenger capacity). A said sensor may be configured in use to detect an amount of luggage in the vehicle (or spare luggage capacity).

The customer device and/or the processing system may send control signals to a driving system to at least partially navigate a vehicle to a pick-up point of the customer and/or to a destination specified in the customer request.

According to another aspect of the present invention there is provided a method of assisting a customer with obtaining a service or a product, the method including or comprising:

receiving a request for a service or product from a customer device;

processing the request to identify at least one potential provider of the service or the product, and optionally:

seeking confirmation from a said identified provider regarding whether the provider is prepared to fulfil the customer request; and/or

providing information relating to the identified at least one potential provider to the customer device; and/or

requesting confirmation of the request from the customer device after providing the information.

According to yet another aspect of the present invention there is provided a stock management method, the method including or comprising:

receiving order data relating to orders for a product or a service, and

updating a stock data store in response to the order data.

According to another aspect of the present invention there is provided a method of informing a passenger regarding a transportation arrangement, the method including:

obtaining data representing a current location of a customer device, and

displaying information on the customer device relating to relative distance (or timing) of the customer device with respect to a pick-up point specified in the transport arrangement.

The invention also covers systems configured to perform methods substantially described as herein. The invention also covers vehicles configured to interact with systems and methods as substantially as described herein.

According to another aspect of the present invention there is provided a computer program element comprising: computer code means to make the computer execute methods substantially as described herein. The element may comprise a computer program product. Client/server embodiments of the invention are also provided.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

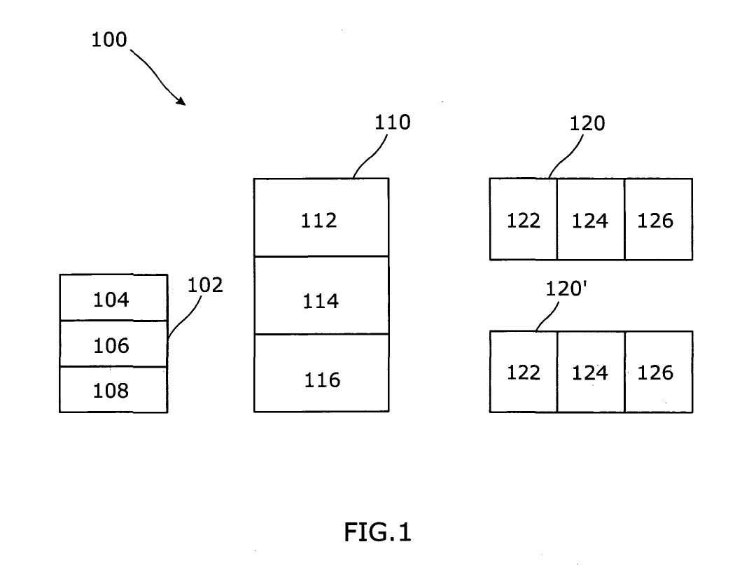

FIG. 1 is a schematic illustration of an example system configured to assist a customer with obtaining a product or service, and

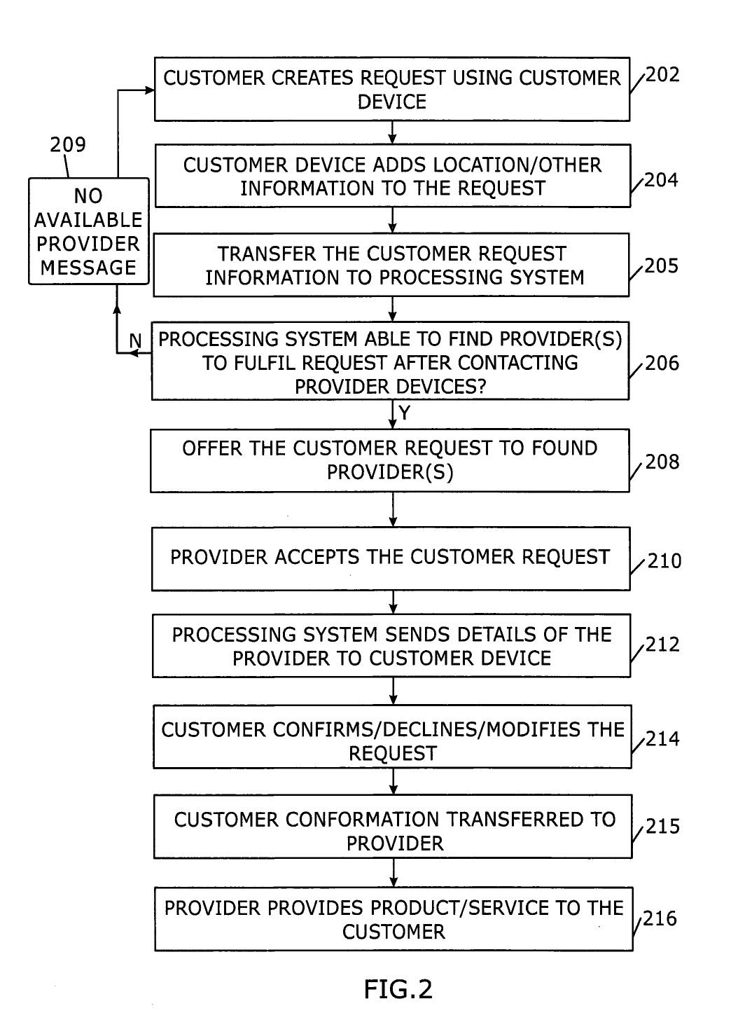

FIG. 2 is a flowchart illustrating example steps performed by components of the system.

FIG. 1 illustrates a system 100 configured to assist a customer with obtaining a product or service. It will be appreciated that the components shown are exemplary only and in other embodiments some of them may be omitted; further components may be present; the number of components may vary, and/or the communication relationships between the components may differ. The example system includes a customer device 102, which may be a portable computing device, such as a laptop, PDA or smartphone that has been configured to interact with other components of the system as described herein. In other embodiments, the customer device may comprise a SatNav/GPS system mounted in a vehicle. In yet another embodiment, the customer device may be a device that is merely useable by a customer rather than belonging/registered exclusively to him, e.g. a public/shared telephone or internet terminal. Some embodiments of the customer device can include a processor 104, a memory 106 and a communications interface 108, with the memory including code that allows the device to function as described herein.

FIG. 1 further shows a processing system 110. The processing system will typically comprise computing resources located at the premises of an operator of the system, although it could be distributed over several sites. In the example this takes the form of a computing device having a processor 112, a memory 114 and a communications interface 116. The interface allows the booking system to communicate with the customer device 102 and other devices, e.g. by means of wireless internet, which may involve satellite links or cellular wireless networks, e.g. 4G, or any other suitable communications technology. In some embodiments, at least part of the system may be Cloud-based. The memory of the processing system includes code that allows it to function as described herein.

Also shown in FIG. 1 are computing devices 120, 120′ that are typically located at, or associated with, providers of goods or services. Only two such devices are shown in the Figure for ease of illustration, but it will be understood that any number of providers, at various locations, can participate in the system. The computing devices can be substantially conventional and typically include processors 122, 122′, memory 124, 124′ and communications means 126, 126′, etc. Typically, a provider computing device 120 stores and provides up-to-date data relating to the availability of goods/services to the processing system 110. Alternatively, in some cases, data relating to availability may be stored and updated directly in the memory 114 of the processing system 110.

FIG. 2 is a flowchart showing example steps can be performed involving at least some of the components of the system 100 of FIG. 1. It will be understood that in alternative embodiments some of the steps shown may be re-ordered and/or omitted. The steps can be implemented using any suitable programming language and data structures. In other embodiments, some of the functions described herein as being performed by a particular component of the system 100 may be performed by another component, e.g. some of the functions performed by the customer device may be performed by the processing system 110, etc.

At step 202, the customer can use the customer device 102 to create a request for a product or service. In some embodiments, the customer device executes a program (e.g. an Android™ or iPhone™ app) to allow creation of the request and the customer can input the request using any interface method, e.g. voice-recognition, touch screen, keyboard/keypad, etc. In other embodiments, the customer may use the device to telephone a service operated by the remote processing system 110, which may be configured to perform speech recognition. The customer may be given a unique identifier which he can disclose to such a system in order to identify his account even if he is using a shared/public device.

In an embodiment where the system is used to order a taxi for the customer, the customer may provide information relating to at least the destination to where he wishes the taxi to take him. Other information, such as the time when he wishes the taxi to pick him up (or the customer can simply indicate that the taxi should get to him “as soon as possible”, which can be set as a default option in the customer's account preferences), the number of people, amount of luggage, whether he wishes to have help with luggage, can also be provided. Some embodiments may offer a choice between the customer sharing a taxi with other bookings (which will usually reduce the cost) or exclusive use of a taxi and the customer can also make a suitable selection. Thus, a typical customer request for a taxi can include the following information, which can be encoded using any suitable data structure/format: pick up location; destination; pick up time; number of persons; luggage information and/or shared/exclusive taxi.

The user's account on the system (which can be set up in a conventional manner in order for the user to use the system, including storing information regarding the customer's identity, payment details, etc) can be configured so that preferences, such as whether he is willing to share a taxi, does/does not need confirmation message with costs (see below), can be stored so that the customer does not always need to make these selections every time he uses the system, thereby saving time.

In an embodiment where the system 100 is used to book a table at a restaurant, the customer may specify a style of cuisine (e.g. French, Thai, modern British, etc); a specific dish, and/or the name of a restaurant/chain. Restaurants, etc, can join the system as providers and their devices 120 can automatically update a data store in the memory 114 of the processing system 110 with information regarding available table times/sizes and may also provide information regarding their menus, wine lists, etc. The customer request can include a booking for a number of person(s)/table, optionally with at least some of the food/drinks pre-ordered (or, in some cases, menu orders to take away) for a certain time and may prepay. The customer may also be able to stipulate how long the booking will last, so the restaurant can base their charge (as discussed below) for the time a table is booked (or give a discount for a table booked for a short amount of time or extend the time free of charge, if the food and drink order is substantial—for example, someone ordering caviar and champagne may be allowed more free table time than someone who just orders a soup). The restaurant can use the booking information, e.g. arrival time, to help with the timing of meal preparation. This can improve efficiency for the restaurant and customer, in particular if time is of the essence. It can also mean that the restaurant receives advanced payment for meals. The booking system can also enable fine-tuned pricing, which can also be linked to supply and demand, if so desired (for example, if supply of certain menu items are getting low then their prices can be increased, and vice versa, etc). Fine-tuning, such as grace period for delayed customer arrivals, can be stipulated by the restaurant in question.

The customer request information to be sent to the processing system 110 from the customer device 102 can include data in addition to that directly provided by the customer to the device. For instance, the customer request may include information regarding the current geographical location of the customer device (e.g. based on a GPS component in the device). In such embodiments, the customer device determines its location and adds it to the request data at step 204. If such a facility is not available then the customer may be required to provide his current location at step 202.

At step 205 the request data is transferred to the processing system 110, typically via an internet link operating over the mobile phone network or any other suitable means.

At step 206 the processing system 110 receives the customer request and processes it in order to attempt to find at least one provider of the requested product/service. This can involve exchanging data with at least one of the provider computing devices 120, 120′ (using any suitable communications network), which may store data relating to current availability of the products/services they can provide. The processing system can use any suitable data processing/searching/matching techniques to try to find at least one provider that would fulfil the customer request. In a simple embodiment, such data processing can involve comparing each requirement of the customer request against a corresponding data element in a database record relating to each provider covered by the system in order to try to identify a provider that can satisfy all the requirements; however, it will be understood that more computationally efficient searching techniques can be used.

In an embodiment where the system 100 is used to order a taxi for the customer, the processing system 110 processes the information it has stored and/or obtained from the provider devices 120, 120′ to try to identify any available taxi(s) that would satisfy the customer request. The system may obtain information regarding which taxis have already been booked and the locations of such bookings, and/or information regarding where each taxi is currently located; taxi fuel levels; when taxi driver plans to take a rest break, refuel and/or finish work, etc. Examples of information relating to taxis that may be processed includes: current location of the taxi; scheduled future locations; location at requested pick up time; details of any current bookings at relevant time (e.g. number of persons, whether that/those persons is/are willing to share, and/or amount of available luggage space), etc.

Taxis may be fitted with sensors or input devices that can communicate with the system 100 to provide information such as the amount of luggage and/or passengers present in the taxi. For example, if two sets of customers are willing to share, then luggage space monitoring devices (including available boot/trunk space monitoring devices and vehicle load/weight sensing devices) can provide information to the system to check if there is sufficient space. Sensors can also be used to monitor the number of passengers in the taxi (seat weight sensors, etc). Alternatively, the taxi driver can update the system with the number of passengers and/or luggage currently onboard via an input device 120. The system can then calculate the spare capacity. The passenger/luggage capacity information may be used by the system to determine the suitability of the taxi for fulfilling a customer request.

In some embodiments, data relating to (predicted) traffic conditions en route between the taxi's starting location, the current location of the customer device and/or the specified destination may also be processed to assess whether a particular taxi will reach the customer and/or the location on time. Traffic condition information may be obtained from resources external to the system 100. The skilled person will be familiar with suitable algorithms and techniques for performing such computations. The system can utilise existing traffic cameras and/or other private cameras/webcams, as well as other existing traffic monitoring systems, etc, such as SatNav/GPS traffic monitoring/tracking, etc, systems, in order to assist with calculating traffic conditions. In order to assist with the scheduling of bookings, given the nature of traffic predictions, a margin for error can be built into the system when these calculations are made.

In an embodiment where the system 100 is used to make a restaurant booking the processing system 110 can check time/table/meal/drink availability details in a database record for a specific establishment if one was named in the customer request. If no specific establishment was included in the customer request then the processing system may carry out a search, e.g. based on the customer device 102 location and the style of cuisine specified in the request. Other factors may also be used to find a suitable restaurant. For example, the system 100 can award restaurants using a “points” system and use this to search/match a customer request. The points system may be based on/similar to Michelin stars, restaurant reviews, press coverage, etc. Regular automatic internet searches (using Google™ or another search engine) can be used to assist with updating the points.

At step 208, if at least one suitable provider was found at step 206 then a message may be sent by the processing system 110 to the provider device 120 (and/or a related device, e.g. a communications device held by a particular taxi driver rather than a central office of the taxi company), asking for confirmation that they are prepared to fulfil the customer request. This message can include at least some of the details of the customer request. The provider may be given an opportunity to set certain features of the product/service to the provided. For example, the cost of the product/service may be adjusted based on factors such as supply/demand, location, date/time of day, etc. This may be done algorithmically (e.g. based on distance, number of passengers and/or amount of luggage for a taxi, cost of ingredients/time of day for restaurant meals), or manually by an operator at the provider.

If the taxi is shared, the charge per passenger can either be simply a straight percentage of the standard taxi fare, or it can be a straight percentage plus an additional charge, so the taxi driver is encouraged to participate in sharing of the taxi. For example, if there are 5 people who share the taxi for 100% of the journey, then they each pay 20% of the taxi fare plus, for example, 10%, so the taxi driver is earning a little more for the inconvenience of having a full taxi all the time (but the sharing customer is still paying less compared to not sharing): for example, a full taxi will lead to higher fuel consumption, more wear and tear on the taxi, etc. If a passenger shares 50% of his journey with a taxi that is at 80% occupancy (for example he shares with 3 passengers (total of 4 taxi passengers) in a 5 passenger capacity London taxi) then the charge is calculated accordingly. Alternatively, weight sensors or the like may be present under each passenger seat, which weigh each passenger, so a precise charge per kilo can be made. The same can be done for luggage. A further alternative is that passengers pay per person but this would not encourage sharing, so the charge could include a discount (calculated on similar lines to above), if sharing does take place. Using some of the above methods can mean that the passenger's payment will be calculated at the time of the actual journey, rather than when the taxi is booked. As the taxi has the passenger's payment details, this charge can be easily processed.

When the system 100 is used to book a taxi, different tariffs can be offered, e.g. according to the time sensitivity of the customer. For example, there can be an “Exclusive (i.e. not shared) Airport” tariff, which might have a higher fee, but offers a higher level of punctuality for destinations, such as catching a plane, business meetings, etc. For example, this booking can be made with a taxi which is not so busy with other bookings, or a taxi which has started a shift, so does not have the backlog of other bookings, or a taxi with a known reliable driver. An example at the other end of the tariff spectrum is a “Shared & Relaxed” tariff, which will be cheaper, but would be shared with at least one other customer and might be booked with a taxi driver late in his shift, where there is more likelihood of a delay due to previous bookings being late, etc. Other examples of tariffs can be a mix of the two aforementioned examples, depending upon how many tariffs the provider wishes to offer. For example, the provider could have an “Exclusive & Relaxed” if a customer does not wish to share, but is more relaxed about the arrival time at destination, etc. Some tariffs can offer compensation for any delays (on a sliding scale according to the tariff, for example), due to the taxi service, etc. Taxi drivers can build up a reliability record with the system 100 (with details being stored in a database relating to the taxi service provider), which can be displayed on the customer device, e.g. a scale of 1 to 10, for example, so the customer can specify whether he wants the most reliable taxi for a higher fee. Indeed, customers can review a taxi after use, in order to help keep the taxi's reliability record up to date, if so desired. This reliability record can include many factors such as cleanliness of taxi, helpfulness of driver, driver's driving standards, punctuality, and so on.

The provider(s) may be given a time limit to confirm whether or not he agrees to the booking. If no confirmation is given in time then the system may select another suitable provider. Alternatively, the system can be set up as an “opt out”, rather than an “opt in”, so that if the provider does not respond within the time limit (say, due to other demands on his attention) then the booking is automatically accepted by him.

In the event that more than one suitable provider was found at step 206 then the processing system may select one of these (e.g. if a particular provider has paid a premium to be selected in such cases). Alternatively, messages may be sent to more than one suitable provider and a mechanism may be used to determine which of several ones that accept the request is actually selected to fulfil it, e.g. the first to confirm or one who offers a lowest price for providing the requested product/service. At step 210, a provider who received the confirmation request can send a message confirming that they will fulfil the request to the processing system 110.

If no suitable provider was found at step 206 then at step 209 a message may be sent to the customer device 102, e.g. details of a provider that most closely, but not fully, met the requirements, or a suggestion to try an alternative request. The customer may then return to step 202 to restart the process.

At step 212, information relating to the provider that accepted the customer request at step 210 (and/or information relating to the precise product/service to be provided) can be sent to the customer device 102 by the processing system 110. In the event that more than one suitable provider was found and confirmed their acceptance to fulfil the request then the customer may be presented with information regarding such providers (and/or or their goods/services) and may be invited to select one of them. In such cases, the selected and non-selected providers are informed accordingly following the customer's selection, with further steps being performed in relation to the selected provider only. For example, in an alternative embodiment where the system 100 is used to order takeaway food the customer may be presented with more than one provider who can supply the food he ordered. Information such as the distance from the customer's current location, the price, collection time, etc, may be provided to the customer in order to help him make a selection.

In an embodiment where the system is used to order a taxi for the customer, the information sent at step 212 can include: location/timetable of the taxi, the estimated time of arrival (if the taxi driver needs a rest break/refuel, etc, this can be taken into account, if so desired) and/or price, etc. Information to help the customer identify the taxi may also be sent, such as license/number plate details, vehicle details, taxi company details, etc. In order to solve the potential problem of the customer not being able to identify the taxi in a street of several taxis (such as in slow traffic), the taxi can have an identifier on its roof or other visible location, which can be seen from several/all angles (e.g. front, back and sides). This identifier can include a device that is communication with the system 100 and can light up in a particular colour when the taxi is at/approaching the customer device 102, so that the customer can correctly identify it. In order to prevent non-booked persons taking the taxi, the customer can show the taxi driver his customer booking details, or the taxi driver can scan the customer's mobile phone or a bank/credit/payment card with a suitable device in order to confirm the customer's identity.

In some cases, a customer can be provided with a card or other account identifier that can be used for paying for goods/services ordered using the system 100. Such a card or the like can include a customer number, which can be shown to a taxi driver, who can scan/process it (like a credit/debit card, etc), if so desired. This card or the like can store/link to at least some of the customer's preferences, as well as identification, payment details (the customer can add credit to the card) and booking details, etc. This card or the like can automatically tally with the booking information of the booked trip, and so the booking can be charged to the card. Loyalty points or the like can be added to the customer's account if so desired. In some cases, a flat fee can be paid for each taxi journey with the sharing/non-sharing calculations leading to the award/deduction of loyalty points, if so desired.

In order to make it clear to other potential taxi customers that a particular taxi has already been booked, the taxi identifier can light up in a particular colour with a sign indicating that it is booked, thereby stopping unnecessary flagging by other potential customers. In other cases the taxi identifier on a taxi that is already pre-booked and on its way to collect a customer can be illuminated in amber, for example (to distinguish from green, which suggests the taxi is available to all customers, and red, which can indicate that the taxi is occupied). Alternatively or additionally, the identifier may be capable of displaying a status message, such as “Booked”, for example. Further, a green light could be matched with the phrase “Available”, for example, and a red light could be matched with the phrase “Occupied”, for example. If so desired, another colour can indicate that the taxi is “Off Duty” or no light can indicate “Unavailable”. If the taxi is occupied by a customer, who is willing to share and the taxi is on its way to collect another sharing customer, then the amber light (for example) can be used or, indeed, an alternative colour can be used.

At step 214, the customer may be given the option to confirm, reject or modify the service request and/or the provider. If the customer accepts then a confirmatory message is sent to the provider at step 215. In some embodiments, the customer device may give the customer a limited amount of time to confirm the booking. If the customer modifies the request then this may result in the current booking being cancelled and processing may effectively return to step 202 onwards in order to find suitable provider for the modified request. In some embodiments, payment can be taken online or via mobile phone, e.g. using a bank account, payment card registered to the customer's account on the system upon the customer providing confirmation.

In an embodiment where the system 100 is used to order a taxi for the customer, if so desired, the customer can track the taxi's progress using a suitable application running on his device 102. When taxi is for example, two minutes, from the pick-up location a notification of this can be sent to the customer device. In case there is a lot of traffic on the road and the taxi cannot be seen by the customer (because, for example, there is a truck between it and the customer, blocking it from view) then the customer device can further assist the customer with locating/identifying the taxi. An application executing on the customer device (possibly in connection with another peripheral device, such as augmented reality goggles) can display an indication of the taxi's location. For example, a taxi location identifier may be superimposed on a real-time camera view of the customer's surroundings if he holds up a viewfinder on his device in front of his field of vision. Arrows or the like on the display can point in the direction that the customer need to move in order to face in the correct direction to get to the taxi. For example, if the taxi is 10 metres to the right of the direction in which the customer device is facing, then an arrow on the display can point right and state “taxi is 10 metres to right” or the like, or the display can state “the taxi is 10 metres, in 2 o'clock direction”, etc. When the customer device is facing in the correct direction then an arrow can then point to the relevant taxi. If the taxi is behind a large truck, for example, then the arrow can be above the taxi, pointing downwards, with a note such as “taxi [the taxi number can be shown on the screen] is behind truck [the name of the truck could also be shown, for example “UPS”]”. In addition, the system device can display information to the taxi driver relating to the location of the customer, so he can identify the customer.

At step 216, the product/service is provided to the customer by the selected provider. In some cases, the system 100 may be utilised further after the product/service has been provided. For example, the customer may be invited to post a review of the product/service/provider. The system may also be used to penalise customers who abuse their bookings in some cases, e.g. if the customer booked a restaurant table for a specific period of time but stays longer than specified then the customer device 102 may detect that they are still at the restaurant location (or the restaurant may notify the system of this using the provider device 120). The customer device may be configured to emit/display a warning and/or a surcharge may be taken from the customer's account in such cases.

In an embodiment where the system 100 is used to book a taxi, if the customer arrives late at the pick-up point then a standard surcharge can be added, if so desired, on a per minute basis, for example (i.e. a waiting time charge). If this causes the taxi to be late for its next booking, then a warning can be shown on the taxi driver's device 120, informing him how long the taxi can wait before leaving for the next booking without being late, as calculated by the system. If the taxi is being shared, then this time keeping will have to be strict, unless the sharing party is not in a hurry, in which case, a “relaxed timetable” can be offered whereby any time beyond, say, a minute, of waiting, the sharing passenger gets a compensatory discount. This discount can be deducted out of the penalty paid by the late customer. If the current sharer customer indicates that he can no longer wait, the taxi sends a message to the device of the second (late) customer, informing him that the taxi will have to leave in, for example, 1 minute and the late customer would still be charged the full or discounted fair (cancellation charge), depending on the system settings even if he does not manage to catch the taxi before it leaves. Alternatively, if the taxi is delayed for reason beyond the driver's control (for example, breaks down), then all its bookings will be transferred by the system to one or more other taxi(s) and those booking customers will be notified if there is a change to their collection time and/or destination arrival time, etc, as a result of this delay. Customers can be offered compensation or refunds if they have a tight schedule and need to make other arrangements and therefore need to cancel the taxi due to the delay. The operator may wish to exclude “Acts of God”, etc, from this optional compensation/refund system.

Embodiments of the system 100 can also give useful information to providers, which can have benefits in terms of focussed advertising, etc. For example, it can give restaurant owners valuable information regarding patterns of popularity of certain products at certain times of the year as well as information regarding customers (if privacy settings/rules allow), e.g. where customers are coming from, etc.

Further, embodiments of the system 100 can assist with stock management systems. For instance, bookings made using the system can be used to update a data store at the provider computing device 120 that particular products have been used or purchased, resulting in a notification being generated for the provider and/or an automatic re-stocking purchase being made, e.g. by interfacing with a suitable wholesale website/purchasing system. Restaurant management can also be tied into embodiments of the system. As mentioned above, stock inventory can be uploaded and updated in real time: when a restaurant joins the scheme then it can upload its entire inventory of stock, etc, and then it is updated when more stock is ordered (or this can be automated). This information can be used for the fine-tuning price adjustments discussed above based on supply and demand.

In an embodiment where the system 100 is used to order a taxi for the customer, at step 216 the taxi travels to the specified location of the customer device 102. A SatNav/GPS onboard the taxi (that is in communication with, or incorporates, the provider device 120) may be used to guide the driver to the pick-up point and/or the destination, etc. In other embodiments, the provider device may at least partially control an automated driving system in the vehicle.

In an embodiment where the system is used to make a restaurant booking then the customer device 102 may be used to provide directions to the restaurant, e.g. using the built-in GPS device.

It will be appreciated that embodiments of the system 100 can be used to order a wide range of products/services other than (or in addition to—the customer may be able to use the same version of the system for multiple types of orders) the main taxi and restaurant examples given above. Alternative applications include booking courier or rescue/emergency services, or ordering food from takeaway, e.g. pizza, establishments. For example, if the customer wants a Pizza Margarita, he simply needs to create an order for the pizza for one person and the system will find nearest available and/or cheapest establishment, as well as other information, such as delivery time. The customer can then confirm, ask for an alternative or decline altogether. Embodiments of the system can also be used to book trains, planes, hotels etc. In some cases, the customer device 102 can be used as a payment device that is “scanned” (e.g. either a code/details displayed on screen or by means of attached/embedded contact-based/contactless device) at various checkpoints on the trip, such as when boarding the train, at an airport check in, etc. Other embodiments of the system can be used for retail businesses, such as plumbing parts, electronics, vehicles, etc. In the case of a car/automobile ordering embodiment of the system, the customer can provide details, such as desired make/model, colour, mileage, and information provided by several retailers/dealers can be searched.

Other embodiments of the system 100 can be applied to other services, such as bus/coach services, etc. In some cases a passenger who has ordered a bus ticket using the system can be sent a mobile phone text alert (or other type of message via his customer device 102) a certain period of time before a bus arrives at the pick-up bus stop. This time period could be two minutes, for example, but may depend on the distance between the location of the customer device and the bus stop a certain time prior to the pick-up time. Bus service providers can update the system with their timetables, etc and, again, traffic cameras and other cameras can monitor the actual locations of the buses.

In some cases, embodiments of the system 100 can even be used by law enforcement authorities or the like. It can also assist traffic management systems, e.g. by providing information regarding whereabouts of taxis in cities, etc. For example, a vehicle licensing authority, such as the DVLA in the UK, and/or vehicle manufacturers/maintenance companies can interface/communicate with at least some components of the system. For example, MOT, road tax, fuel emissions controls (via emissions measurements of the exhaust, etc built into the vehicle), on board vehicles diagnostics, etc. In some cases, sensors and processors onboard a vehicle may be used to perform diagnostic checks or service/MOT, with a customer device linked to the vehicle being used to relay the information to other appropriate entities. Also, an authority such as the DVLA can send MOT and road tax reminders to a vehicle/customer device. Embodiments of the system may even be used to notify DVLA/Police, etc if, for example, sensors indicated that the vehicle is exceeding a speed limit in a geographical area, or breaking any other highway code rules, etc.

1-51. (canceled)

52. A computer-implemented method of assisting a customer with obtaining a service or a product, the method including:
receiving (205, 206), via a computer interface, a request for a service or product from a customer device (102);
processing (206), by a processor, the request to identify at least one potential provider of the service or the product, and
sending (212), via a computer interface, provider information relating to at least one of the identified potential providers to a customer device.

53. A method according to claim 52, further including:
requesting (214) confirmation from customer device after providing the providing information, and
upon the customer device giving the requested confirmation then sending (215), via said computer interface, a confirmation signal to a provider in the provider information.

54. A method according to claim 53, wherein the customer request includes details regarding current location of the customer device, obtained by means of a gps device.

55. A method according to claim 54, wherein the step of processing (206) the request includes comparing by said processor, a current location of the customer device (102) with a location of a provider.

56. A method according to claim 52, wherein the method includes, prior to the step of providing (212) the provider information, a step of seeking (208, 210) confirmation from a said identified provider regarding whether the identified provider agrees to the provider information being provided to the customer device (102).

57. A method according to claim 52, wherein the method includes, prior to the step of providing (212) the provider information, a step of seeking (208, 210) confirmation within a time limit, that the provider is prepared to fulfil the customer request, and
wherein if no confirmation is received within the time limit then automatic confirmation is provided on behalf of the provider.

58. A method according to claim 57, wherein if the step of processing (206) the request identifies a plurality of said potential providers then the method further includes selecting a first of the potential providers to accept (214)

59. A method according to claim 52, including updating a data store holding product, or service-related, stock information for a said provider in view of provision of the product or the service to the customer.

60. A method according to claim 59, further including producing a re-stocking order as a result of the stock information updating; and/or
including calculating a price for the product/service specified in the customer request.

61. A method according to claim 52, wherein the service comprises a taxi service.

62. A method according to claim 61, wherein the customer request includes one or more of details of a destination; information regarding a time when the customer wishes to be picked up by a taxi; number of passengers; customer luggage; an indication of whether the customer is prepare to share a taxi with another customer and/or an indication of whether the customer requires exclusive use of the taxi with no other customers.

63. A method according to claim 62, including calculating a price for the taxi service, the calculation of the price of the taxi involving processing a distance relating to a pick up point and destination; a number (or weight) of passengers; an amount (or weight) of luggage; and/or whether the customer is sharing at least part of the taxi journey with at least one other customer (who made an independent request).

64. A method according to claim 62, wherein the step of processing (206) the request includes obtaining information regarding locations of taxis; information regarding schedules of taxis; information regarding fuel levels of taxies; information regarding timing of rest breaks/working hours of drivers of taxis; information regarding traffic conditions between a current location of a taxi and the current location of the customer device, and/or information regarding traffic conditions between the current location of the customer device and the specified destination.

65. A method according to claim 62, further including displaying information regarding a current location of the taxi on the customer device (102),
wherein the current taxi location information is displayed in a graphical format, including directions to the current taxi location with respect to a current location of the customer device (102).

66. A method according to claim 52, wherein the service comprises a restaurant booking.

67. A method according to claim 66, wherein the customer request includes information regarding one or more of food and/or drink to be included in the restaurant booking;
a start time for the restaurant booking; an end time and/or a desired duration of the restaurant booking; a specified name of a restaurant;
a specified style of cuisine and the step of processing (206) the customer request includes identifying restaurants that provide the specified style of cuisine.

68. A method according to claim 66, further including displaying direction to a restaurant on the customer device (102).

69. A method according to claim 52, wherein the service comprises a mass transport service, such as a bus or coach.

70. A method according to claim 69, further including sending a message to the customer device (102) prior to the transport service arriving at a pick-up point, and wherein a time at when the message is sent is calculated based on a distance between a current location of the customer device (102) and the pick-up point.

71. A method according to claim 52, wherein the product comprises takeaway food or consumer goods.

72. A method according to claim 52, wherein the service comprises a courier; a rescue/emergency service; a travel ticket; or holiday accommodation.

73. A system including:
a customer device (102) configured to produce a request for a service or product;
a processing system (110) configured to:
receive (205, 206) the request from the customer device (102); and
process (206) the request to identify at least one potential provider of the service or the product, and
send (212) provider information relating to the identified at least one potential provider to the customer device.

74. A system according to claim 73, wherein the customer device (102) is further configured to send (214) confirmation to the processing system (110) after receiving the provider information.

75. A system according to claim 73, further including an identification device for a vehicle, the identification device including a communications device for receiving a signal from the processing system (110) and/or the customer device (102),
wherein the identification device changes visibly (e.g. lights up) upon receipt of a signal from the processing system (110) or the customer device (102) in order to assist the customer with identifying the vehicle;
wherein the identification device is configured to convey a taxi status, e.g. occupied, available, available to share, or unavailable.

76. A system according to claim 52, further including at least one vehicle-mounted sensor.

77. A system according to claim 76, wherein a said sensor is configured in use to detect a number of passengers in the vehicle (or spare passenger capacity); and/or
to detect an amount of luggage in the vehicle (or spare luggage capacity).

78. A system according to claim 76, wherein the customer device (102) and/or the processing system (110) is configured to send control signals to a driving system to at least partially navigate a vehicle to a pick-up point of the customer and/or to a destination specified in the customer request.
